(19) United States
(12) Patent Application Publication
(10) Pub. No.: US 2007/0094694 A1
(43) Pub. Date: Apr. 26, 2007

(54) Method of controlling download speed of broadcast receiving device and apparatus for the same

(75) Inventors: Jong-il Choi, Seoul (KR); Kyung-soo Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/583,913

(22) Filed: Oct. 20, 2006

(30) Foreign Application Priority Data
Oct. 20, 2005 (KR) 10-2005-0099231

(51) Int. Cl. H04N 7/173

(52) U.S. Cl. 725/93

(57) ABSTRACT

A method of controlling the download speed of a broadcast receiving device and an apparatus using the same are disclosed. The method includes monitoring processing resources consumed by a broadcast receiving device, and controlling the download speed according to the monitoring result, where the download is performed via an Internet Protocol communication.

### CROSS-REFERENCE TO RELATED APPLICATION

This application is based on and claims priority from Korean Patent Application No. 10-2005-0099231 filed on Oct. 20, 2005 in the Korean Intellectual Property Office, the disclosure of which is incorporated herein in its entirety by reference.

### BACKGROUND OF THE INVENTION

1. Field of the Invention

Methods and apparatuses consistent with the present invention relate to controlling the download speed of a broadcast receiving device, and more particularly, to dynamically controlling the download speed according to an operating state of the broadcast receiving device when the broadcast receiving device configured based on the Internet Protocol (IP) downloads data.

2. Description of the Related Art

As broadcast technology is developed, digital broadcasts are increasingly being spread via satellite, terrestrial wave, and cable broadcasts. A user uses a broadcast receiving device such as a set-top box or a digital TV in order to receive the digital broadcasts provided by a broadcast provider. In the digital broadcasts, the image and sound streams are output as compressed digital information. A broadcast receiving device that received the streams uncompresses the image and sound streams, and then outputs the uncompressed streams.

The set-top box and the digital TV, which have been developed to receive and output the digital broadcasts, provide several functions not available in a conventional analog TV environment. For example, the digital broadcast includes electronic program guide (EPG) information showing broadcast programs as well as images and sounds. Accordingly, a user can obtain information on broadcast programs (e.g., day, channel, and time).

An IP-based broadcast receiving device is preferable because it has an IP communication function with a broadcast receiving function. A user can receive an interactive service from a broadcast provider or access the Internet via the IP-based broadcast receiving device. The user can also stream or download various multimedia data such as movies, music, and games.

In general, the broadcast receiving device has fewer processing resources than a personal computer (PC). If predetermined data is being downloaded while a user operates an application for playing a movie or running a game, the user cannot receive a good service because processing resources of the broadcast receiving device are consumed in downloading data and operating the application.

To solve this problem, a set-top box, which includes several control units to control several controlled devices independently, is disclosed in Korean Laid-open Patent Publication No. 10-2005-0019282: Digital Set-top box and Program Download Method for Digital Set-top Box, which enables a user to use a controlled device with a certain quality by downloading programs via the control unit connected to the controlled device. However, Korean Laid-open Patent Publication No. 10-2005-0019282 cannot solve the problem of the conventional set-top box having a single control unit.

### SUMMARY OF THE INVENTION

The present invention provides a broadcast-receiving device which ensures a quality of the service by controlling download speed dynamically.

According to an aspect of the present invention, there is provided a method of controlling the download speed of a broadcast receiving device, the method including monitoring the processing resources consumed by a broadcast receiving device, and controlling the download speed according to the monitoring result, wherein the download is performed via an Internet Protocol communication.

According to another aspect of the present invention, there is provided a method of controlling the download speed of a broadcast receiving device, the method including monitoring various applications operated by a broadcast receiving device, and controlling the download speed according to the monitoring result, wherein the download is performed via an Internet Protocol communication.

According to a further aspect of the present invention, there is provided an apparatus for controlling the download speed, the apparatus including a monitoring module that monitors the processing resources consumed by a broadcast receiving device, and a control module that controls the download speed according to the monitoring result, wherein the download is performed via an Internet Protocol communication.

According to another aspect of the present invention, there is provided an apparatus for controlling the download speed, the apparatus including a monitoring module that monitors various applications operated by the broadcast receiving device, and a control module that controls the download speed according to the monitoring result, wherein the download is performed via an Internet Protocol communication.

### BRIEF DESCRIPTION OF THE DRAWINGS

The above and other aspects of the present invention will become apparent by describing in detail exemplary embodiments thereof with reference to the attached drawings, in which:

FIG. 1 is a block diagram illustrating a broadcast-receiving device according to an exemplary embodiment of the present invention;

FIG. 2 is a block diagram illustrating a download-speed controlling device according to an exemplary embodiment of the present invention;

FIG. 3 depicts a storing status of monitoring result of processing resource according to an exemplary embodiment of the present invention;

FIGS. 4A and 4B show information on an appropriate download speed according to the processing-resource consumption according to an exemplary embodiment of the present invention;

FIG. 5 is a flowchart that illustrates a monitoring operation of a broadcast-receiving device according to an exemplary embodiment of the present invention;

FIG. 6 is a flowchart showing a method of controlling the download speed according to an exemplary embodiment of the present invention;

FIG. 7 is a flowchart that shows a monitoring operation of a broadcast-receiving device according to another exemplary embodiment of the present invention;

FIG. 8 is a flowchart showing a method of controlling the download speed according to another exemplary embodiment of the present invention.

### DETAILED DESCRIPTION OF EXEMPLARY EMBODIMENTS

Exemplary embodiments of the present invention will be described in detail with reference to the accompanying drawings.

Aspects of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

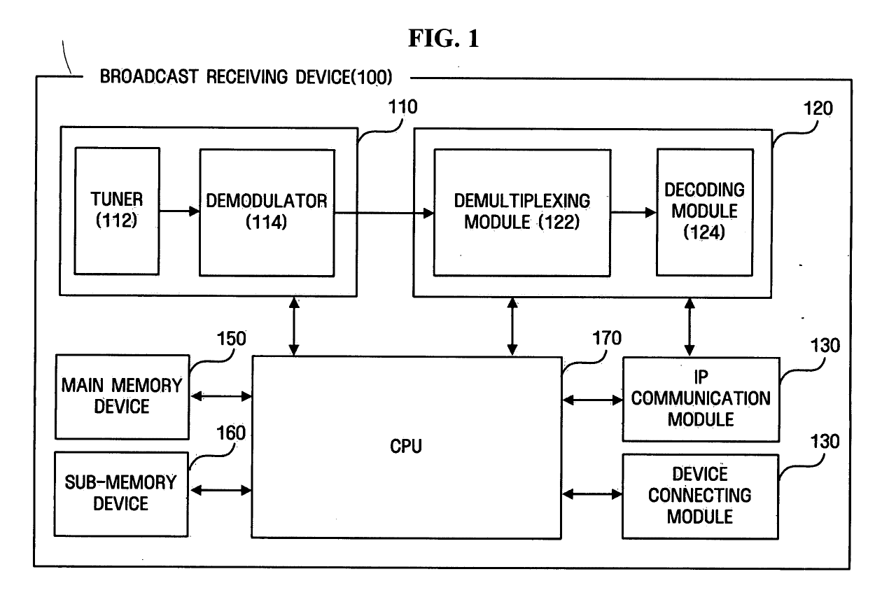

FIG. 1 is a block diagram illustrating a broadcast-receiving device 100 according to an exemplary embodiment of the present invention.

The broadcast-receiving device 100 illustrated in FIG. 1 includes a broadcast-signal-receiving module 110, a restoration module 120, an IP communication module 130, a device-connecting module 140, a main memory device 150, a sub-memory device 160, and a central processing unit (CPU) 170. The broadcast-receiving device 100 may be embodied as an IP-based set-top box and a digital TV.

The broadcast-signal-receiving module 110 receives broadcast signals, and includes a tuner 112 and a demodulator 114.

The tuner 112 receives broadcast signals, converts them into intermediate frequency (IF), and provides the IF to the demodulator 114. For example, the tuner 112 detects an in-phase/quadrature-phase (I/Q) signal by processing signals received by a satellite and may provide the detected I/Q signal to the demodulator 114.

The demodulator 114 restores a transport stream from the converted IF, and provides the restored transport stream to the restoration module 120. For example, the demodulator 114 may consist of a quadratic phase shift keying (QPSK) demodulator (not shown) and a forward error correction (FEC) demodulator (not shown), thereby performing QPSK demodulation and FEC demodulation.

The broadcast signal, which is received by the broadcast-signal-receiving module 110, is not limited to satellite, terrestrial wave, and cable broadcasts.

The restoration module 120 restores video, audio, and data signals by using the transport stream. The restoration module 120 includes a demultiplexing module 122 and a decoding module 124.

The demultiplexing module 122 separates video, audio, and data signals by parsing the transport stream, and provides the signals to the decoding module 124.

The decoding module 124 includes a video decoder (not shown) and an audio decoder (not shown), which respectively decode the provided video and audio signals from the demultiplexing module 122. The video decoder is embodied according to video decompression methods such as the moving picture experts group-2 (MPEG-2) and the moving picture experts group-4 (MPEG-4). The audio decoder is embodied according to audio decompression methods such as the MPEG layer-3 (MP3) and the audio compression 3 (AC3).

The decoding module 124 includes a data decoder (not shown) that decodes a data signal provided from the demultiplexing module 122. The data signal includes electronic program guide (EPG) data that includes information on a broadcast program such as a channel number, a broadcast date, a broadcast start time, a content identifier, and a program description.

The IP communication module 130 supports IP-based communication. For example, the IP communication module 130 may access the Internet via cable, a telephone wire, or an x digital subscriber line (xDSL). The broadcast-receiving device 100 is connected to a broadcast provider via the IP communication module 130, thereby providing an interactive service.

According to an exemplary embodiment, the broadcast-receiving device 100 may receive a broadcast signal via the IP communication module 130. In this case, the restoration module 120 restores the broadcast signal received by the IP communication module 130.

The device-connecting module 140 communicates with an audio/video (AV) device (not shown). For example, the device-connecting module 140 may be connected to a TV or a personal video recorder (PVR). When communicating with the AV device, a security protocol such as the high-bandwidth digital content protection (HDCP) and the digital transmission content protection (DTCP) may be used to prevent an unauthorized copy of content.

The main memory device 150 stores information needed in the case of operating a program stored in the sub-memory device 160, or driving a predetermined application. That is, the main memory device 150 may store input/output information and an interim result based on operation of the CPU 170. The main memory device 150 may include RAM such as SRAM and DRAM, and ROM such as EPROM, EEPROM and MASK-ROM.

The sub-memory device 160 stores several types of data such as multimedia content, firmware, and an application operating program. The sub-memory device 160 may include a hard disk and flash memory. FIG. 1 shows that the sub-memory device 160 is included in the broadcast-receiving device 100; however, the present invention is not limited thereto. The sub-memory device 160 may be separate from the broadcast-receiving device 100 so the sub-memory device 160 is connected to the broadcast-receiving device 100 via the device-connecting module 140.

The CPU 170 compares, determines, computes, and analyzes the various operations performed by the broadcast-receiving device 100. The CPU 170 controls the functional blocks 110 to 160 that constitute the broadcast receiving device 100.

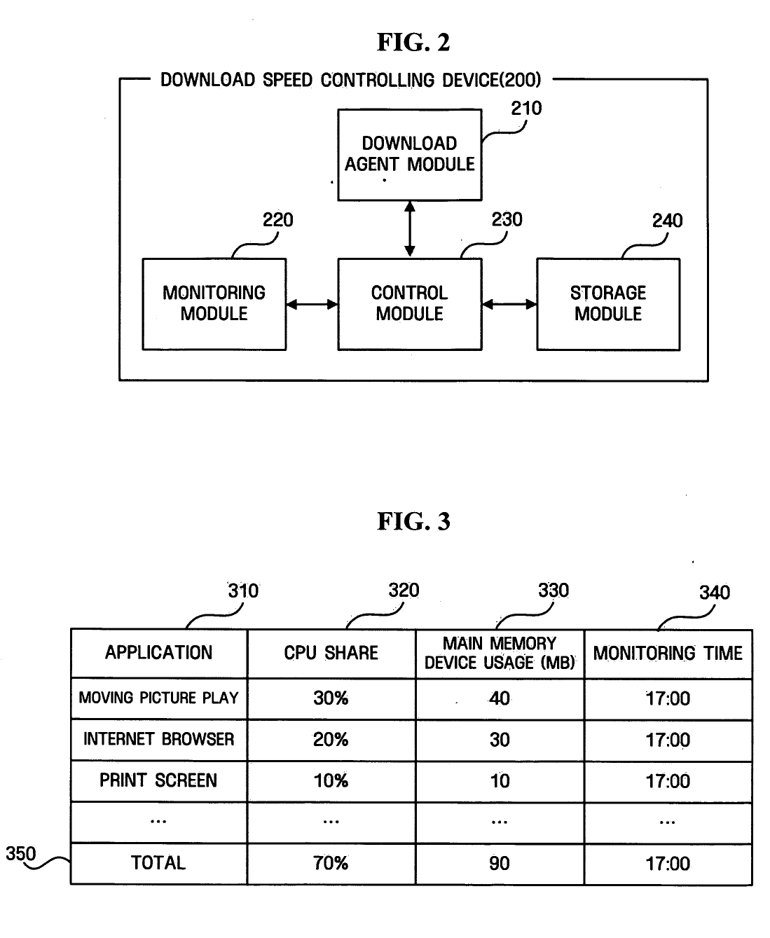

FIG. 2 is a block diagram illustrating a download-speed controlling device 200 according to an exemplary embodiment of the present invention.

The illustrated download-speed controlling device 200 includes a download agent module 210, a monitoring module 220, a control module 230, and a storage module 240. The download-speed controlling device 200 is stored in software form in the sub-memory device 160. When the broadcast receiving device 100 is booted, the download speed controlling device 200 is embodied on the main memory device 150 by the CPU 170 or is embodied by hardware, and then is included in the broadcast-receiving device 100. In detail, the term “module”, as used herein, means, but is not limited to, a software or hardware component, such as a Field Programmable Gate Array (FPGA) or an Application Specific Integrated Circuit (ASIC), which executes certain tasks. A module may advantageously be configured to reside in the addressable storage medium, and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules, or further separated into additional components and modules.

Hereinafter, the modules 210 to 240 that compose the download-speed-controlling device 200 will be described.

The download agent module 210 downloads predetermined data from a broadcast provider, a content provider, and the other servers via the IP communication module 130. Here, the data is not limited to types of multimedia contents such as movies, music and games, and firmware. The data downloaded via the download agent module 210 is stored in the sub-memory device 160 of the broadcast receiving device 100. The download speed is controlled by the control module 230.

Data may be downloaded upon a user's request. When the user accesses a website that provides contents via the broadcast receiving device 100 in order to download video on demand (VOD) contents, the download agent module 210 downloads VOD contents from the corresponding website via the IP communication module 130; however, the present invention is not limited thereto. Also, data may be periodically downloaded at a predetermined time. For example, the download agent module 210 may download three movies from a content provider every Monday 7:00 AM.

The monitoring module 220 monitors an operating state of the broadcast-receiving device 100.

When the broadcast-receiving device 100 operates a predetermined application, the monitoring module 220 may monitor the processing resources consumed in operating the application. The processing resources include CPU 170 usage, main memory device 150 usage, and input/output frequency of the sub-memory device 160, which are needed in order for the broadcast receiving device 100 to perform a predetermined operation. The monitoring module 220 may monitor one or more processing resources. If the broadcast receiving device 100 simultaneously operates several applications, the monitoring module 220 may monitor the processing resources consumed by application.

The monitoring module 220 monitors various applications (e.g. playing a moving picture and audio, and running a web browser and a game) operated by the broadcast-receiving device 100.

The storage module 240 stores the monitoring result of the monitoring module 220. If the monitoring module 220 monitors processing resources, the storage module 240 stores a processing resource table as illustrated in FIG. 3.

The table illustrated in FIG. 3 includes an application 310 operated by the broadcast receiving device 100, the processing resources consumed in operating applications (i.e., CPU usage 320 and main memory device usage 330), and a monitoring time 340. The table illustrated in FIG. 3 includes the total amount of processing resources consumed in operating applications (refer to the “TOTAL” line 350), which may be calculated by the storage module 240. FIG. 3 depicts the CPU 320 and the main memory device usage 330 as an example of processing resources; however, the present invention is not limited thereto.

The control module 230 may refer to the stored monitoring result in the storage module 240 so the control module 230 dynamically controls the download speed based on the monitoring result of the monitoring module 220.

When the monitoring module 220 monitors the processing resources consumed in operating applications, the control module 230 may control the download speed according to the remaining available processing resources of the broadcast receiving device. If the CPU usage is monitored by the monitoring module 220, the control module 230 may decrease the download speed when the CPU usage increases. According to the monitoring result, the download speed may be decreased when the available processing resources in the broadcast receiving device 100 decrease, and the download speed may increase as the available processing resources in the broadcast receiving device 100 increase. According to exemplary embodiments, the monitoring module 220 may monitor the consumption of one or more types of processing resources, and the control module 230 may control the download speed by applying the processing resources.

In order to control the download speed, information may be used on the appropriate download speed based on the processing resource consumption of the broadcast receiving device 100. The information may be provided through a test performed when the broadcast receiving device 100 is produced, and it may be stored in the storage module 240.

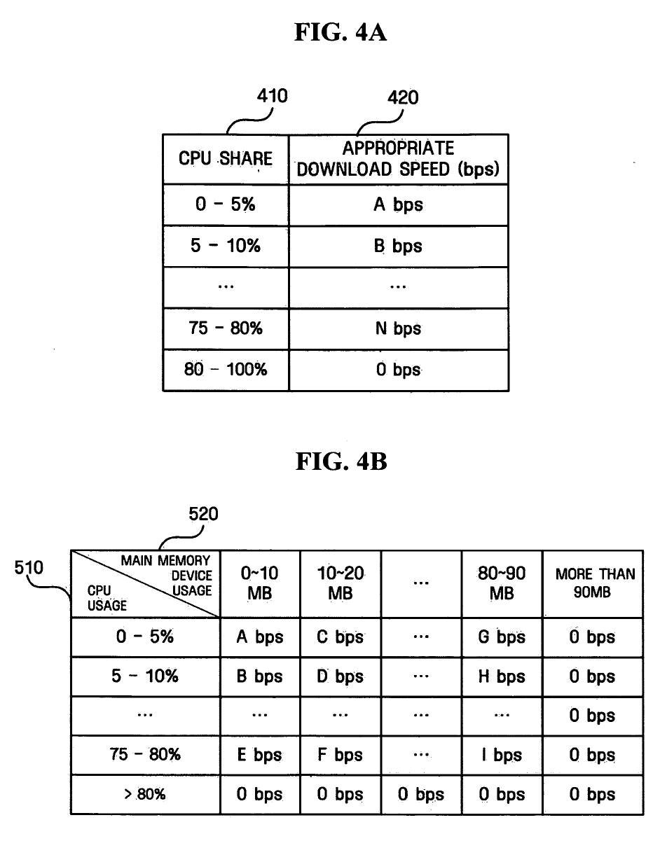

Information on the appropriate download speed based on the processing resource consumption is illustrated as a table in FIGS. 4A and 4B according to an exemplary embodiment of the present invention.

In FIG. 4A, a CPU usage 410 is used as the measure of the processing resource consumption and an appropriate speed 420 based on each CPU usage is shown. As illustrated in FIG. 4A, the download-speed controlling device 200 stops downloading data when the processing resource consumption is more than a critical value. (Refer to the appropriate speed of “0” when the CPU share is more than 80%.)

FIG. 4A shows information on the download speed based on the processing resource consumed (the CPU usage); however, the present invention is not limited thereto. In FIG. 4B, two types of processing resource (CPU usage 510 and main memory device usage 520) are used in order to control the download speed. The appropriate download speed for the broadcast receiving device 100 is provided based on the CPU usage 510 and the main memory device usage 520 in FIG. 4B. Other information on other types of processing resource such as input/output frequency of the sub-memory device may be used to adjust the download speed.

As another exemplary embodiment for controlling the download speed, when the monitoring module 220 monitors what type of application is operating, the control module 230 may lower the download speed to less than a certain level or stop the download if a predetermined type of application is operating. A number of processing resources are needed to play a moving picture or a game, so the download speed may be set as “0” when the application for playing a moving picture or a game is operating. Information on the type of application may be set in advance, thereby decreasing the download speed if the set application is operated. The information may be stored in the storage module 240.

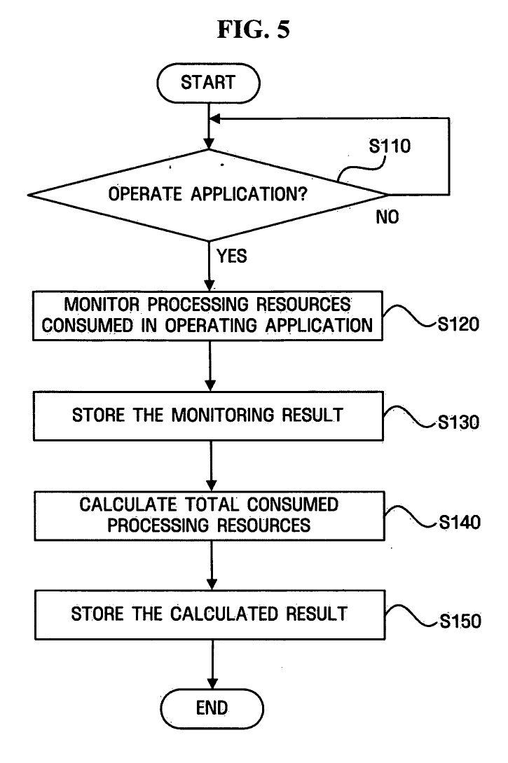

Operation of the download-speed controlling device 200 will be described with reference to FIGS. 5 to 8 in the following.

FIG. 5 is a flowchart that illustrates the monitoring operation of a broadcast receiving device 100 according to an exemplary embodiment of the present invention.

When power is supplied to the broadcast-receiving device 100, the download speed controlling device 200 may be operated.

If the broadcast receiving device 100 operates a predetermined application according to the environment set in advance or a user's request S110, the monitoring module 220 monitors the processing resources consumed by the operating application SI 20.

The storage module 240 may store the monitoring result S130. At this time, the storage module 240 calculates a total amount of processing resources used by the broadcast receiving device 100 S140, and then stores the calculated result S150. The monitoring result and the calculated result are the same as that described with reference to FIG. 3.

It is desirable to periodically perform the monitoring operation, thereby updating the monitoring result stored in the storage module 240 periodically. The monitoring operation may be continued while the broadcast receiving device 100 is being operated.

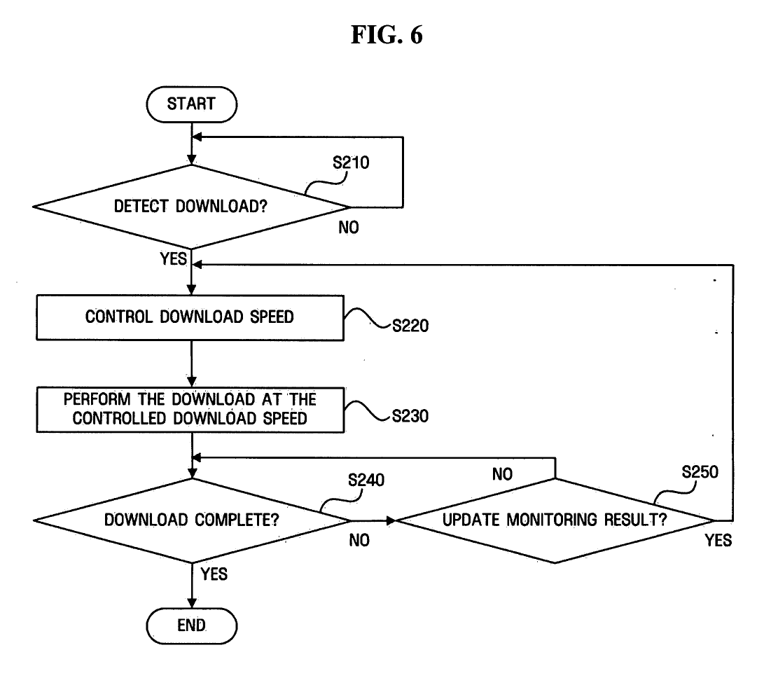

Operation of the download-speed controlling device 200 in case of downloading predetermined data via the IP communication module 130 will be described with reference to FIG. 6.

FIG. 6 is a flowchart showing a method of controlling the download speed according to an exemplary embodiment of the present invention.

When the download agent module 210 detects the data download via the IP communication module 130 S210, the control module 230 controls the download speed through the monitoring result in the same manner as that described by reference to FIG. 5 S220.

The download agent module 210 downloads data at the speed controlled by the control module 230 S230.

When the download is not completed S240, if the result of monitoring the processing resources consumed by the broadcast receiving device 100 is updated S250, the control module 230 controls the download speed through the updated result S220, and the download agent module 210 downloads data at the controlled speed S230.

Accordingly, the download speed is dynamically increased or decreased according to the processing resources consumed in operating the application. As described above, the download speed is decreased or set as “0” (i.e. stopped downloading data) as the processing resources consumption of the broadcast receiving device 100 increases. If the processing-resource consumption of the broadcast receiving device 100 decreases, the download speed may be increased. At this time, the stopped download may be restarted.

Although predetermined data is downloaded while a user is receiving a specific service via the broadcast receiving device 100, it is possible to ensure the service quality provided to a user. Although download speed is decreased or a data download is stopped, if the processing resource consumption of the broadcast receiving device 100 is decreased, the download speed is increased again or the data download is restarted, thereby successfully completing the data download.

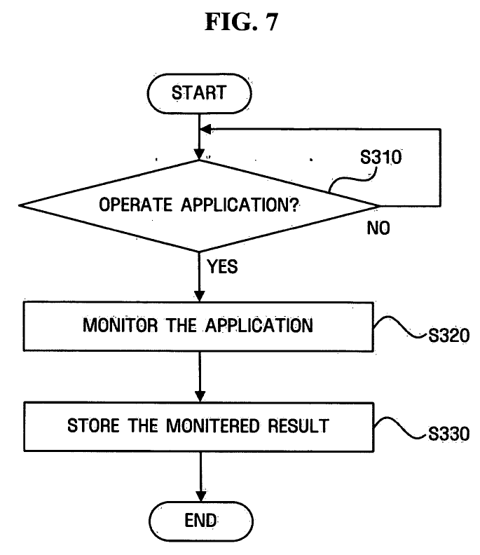

FIG. 7 is a flowchart that shows the monitoring operation of a broadcast receiving device according to another exemplary embodiment of the present invention.

When power is supplied to the broadcast receiving device 100, the download speed controlling device 200 may be operated.

If the broadcast receiving device 100 operates a predetermined application according to the environment set in advance or at a user's request E 310, the monitoring module 220 monitors the processing resources consumed by the operating application S320.

The storage module 240 may store the monitoring result S330.

It is desirable to periodically perform the monitoring operation, thereby updating the monitoring result stored in the storage module 240 periodically. The monitoring operation may be continued while the broadcast receiving device 100 is being operated.

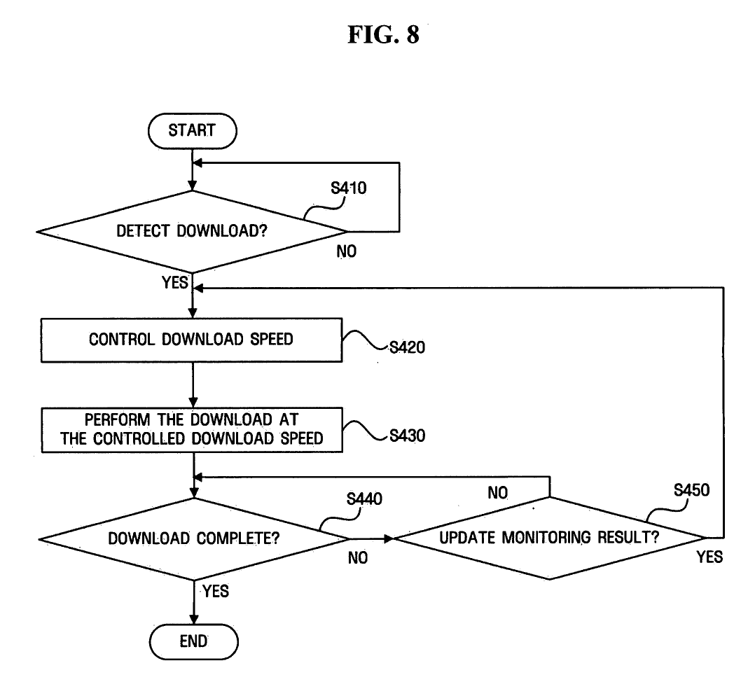

Operation of the download speed controlling device 200 in the case of downloading predetermined data via the IP communication module 130 will be described with reference to FIG. 8.

FIG. 8 is a flowchart showing a method of controlling download speed according to another exemplary embodiment of the present invention.

When the download agent module 210 detects the data download via the IP communication module 130 S410, the control module 230 controls the download speed through the monitoring result in the same manner as that described with reference to FIG. 7 S420. To describe S420 in detail, if the broadcast receiving device 100 operates a specific application set in advance, the control module 230 may decrease the download speed to a critical level or stop the data download. It is possible to search the storage module 240 for the type of application that is being operated by the broadcast receiving device 100.

The download agent module 210 downloads data at the speed controlled by the control module 230 S430. If the application set in advance is stopped being operated, the control module 230 may increase the download speed or restart the stopped data download.

Accordingly, the download speed may be dynamically controlled according to types of application operated by the broadcast receiving device 100.

According to the exemplary embodiments of the present invention, it is possible to dynamically control the download speed, thereby ensuring a quality of the service used by a user via the broadcast receiving device.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling a download speed of a broadcast receiving device, the method comprising:
monitoring at least one processing resource consumed by a broadcast-receiving device; and
controlling the download speed according to the monitoring result, wherein the download is performed via an Internet Protocol communication.

2. The method of claim 1, wherein the at least one processing resource comprises at least one of CPU usage, main memory usage, and input/output frequency of the sub-memory device.

3. The method of claim 1, wherein the controlling the download speed comprises:
decreasing the download speed as the processing resource consumption of the broadcast receiving device increases; and
increasing the download speed as the processing resource consumption of the broadcast receiving device decreases.

4. The method of claim 1, wherein the controlling the download speed comprises:
stopping the download if the processing resource consumption of the broadcast receiving device is more than a critical value; and
restarting the download if the processing resource consumption of the broadcast receiving device is less than the critical value.

5. The method of claim 1, wherein the controlling the download speed comprises searching mapping information on the download speed based on predetermined processing resource consumption for the download.

6. The method of claim 1, wherein the mapping information is provided through a test performed when the broadcast receiving device is produced.

7. The method of claim 1, further comprising downloading data at the controlled download speed.

8. The method of claim 1, wherein the monitoring the at least one processing resource is periodically performed to update the monitoring result while the broadcast receiving device is being operated.

9. A method of controlling a download speed of a broadcast receiving device, the method comprising:
monitoring a type of an application operated by a broadcast receiving device; and
controlling the download speed according to the monitoring result, wherein the download is performed via an Internet Protocol communication.

10. The method of claim 9, wherein the controlling the download speed comprises decreasing the download speed if the broadcast receiving device operates a predetermined application.

11. The method of claim 9, wherein the controlling the download speed comprises:
stopping the download if the broadcast receiving device operates a predetermined application; and
restarting the download if the broadcast receiving device stops operating the predetermined application.

12. The method of claim 9, further comprising downloading data at the controlled download speed.

13. The method of claim 9, wherein the monitoring the type of the application is periodically performed to update the monitoring result while the broadcast receiving device is being operated.

14. An apparatus that controls a download speed, comprising:
a monitoring module that monitors at least one processing resource consumed by a broadcast receiving device; and
a control module that controls the download speed according to the monitoring result, wherein the download is performed via an Internet Protocol communication.

15. The apparatus of claim 14, wherein the at least one processing resource comprises at least one of CPU usage, main memory usage, and input/output frequency of the sub-memory device.

16. The apparatus of claim 14, wherein the control module decreases the download speed as the processing resource consumption of the broadcast receiving device increases, and increases the download speed as the processing resource consumption of the broadcast receiving device decreases.

17. The apparatus of claim 14, wherein the control module stops the download if the processing resource consumption of the broadcast receiving device is more than a critical value, and restarts the download if the processing resource consumption of the broadcast receiving device is less than the critical value.

18. The apparatus of claim 14, further comprising a storage module that stores mapping information on the download speed based on predetermined processing resource consumption, wherein
the control module searches the mapping information on the download speed corresponding to the monitored processing-resource consumption, and sets the download speed to a corresponding download speed.

19. The apparatus of claim 14, wherein the mapping information is provided through a test performed when the broadcast receiving device is produced.

20. The apparatus of claim 14, further comprising a download agent module that downloads data at the controlled download speed.

21. The apparatus of claim 14, wherein the monitoring the at least one processing resource is periodically performed by the monitoring module to update the monitoring result while the broadcast receiving device is being operated.

22. An apparatus for controlling a download speed, comprising:
a monitoring module that monitors a type of an application operated by a broadcast receiving device; and
a control module that controls the download speed according to the monitoring result, wherein the download is performed via an Internet Protocol communication.

23. The apparatus of claim 22, wherein the control module decreases the download speed if the broadcast receiving device operates a predetermined application.

24. The apparatus of claim 22, wherein the control module stops the download if the broadcast receiving device operates a predetermined application, and restarts the download if the broadcast receiving device stops operating the predetermined application.

25. The apparatus of claim 22, further comprising a download agent module that downloads data at the controlled download speed.

26. The apparatus of claim 22, wherein the monitoring the type of the application is periodically performed by the monitoring module to update the monitoring result while the broadcast receiving device is being operated.
